(19) United States
(12) Patent Application Publication
(10) Pub. No.: US 2017/0266556 A1
(43) Pub. Date: Sep. 21, 2017

(54) PROGRAM AND SYSTEM

(71) Applicant: KABUSHIKI KAISHA SQUARE ENIX (also trading as SQUARE ENIX CO., LTD.), Tokyo (JP)

(72) Inventors: Daisuke MOTOHASHI, Tokyo (JP); Kiminori ONO, Tokyo (JP)

(73) Assignee: KABUSHIKI KAISHA SQUARE ENIX (also trading as SQUARE ENIX CO., LTD.), Tokyo (JP)

(21) Appl. No.: 15/459,299

(22) Filed: Mar. 15, 2017

(30) Foreign Application Priority Data
Mar. 16, 2016 (JP) 2016-052179

(51) Int. Cl. A63F 13/56; A63F 13/52; A63F 13/812; A63F 13/45

(52) U.S. Cl. CPC A63F 13/56; A63F 13/45; A63F 13/52; A63F 13/812

(57) ABSTRACT

A non-transitory computer-readable medium including a program causing a user terminal to realize functions to control progress of a video game is provided. The functions include: a displaying function configured to display a game image containing a moving object, a game field, and an operation object, the moving object moving in accordance with a virtual attractive force, the moving object being movable in the game field, the operation object being formed in the direction of the attractive force in the game field; a first action controlling function controlling an action of the moving object so that the moving object finally stops at a predetermined portion of the operation object; and a second action controlling function controlling an action of the moving object in a movement mode, the movement mode being determined in accordance with an input from a user when the moving object is in contact with the predetermined portion.

### CROSS-REFERENCE TO RELATED APPLICATION

The present application relates to subject matter contained in Japanese Patent Application No. 2016-52179 field on Mar. 16, 2016, the disclosure of which is expressly incorporated herein by reference in its entirety.

### BACKGROUND OF THE INVENTION

1. Field of the Invention

At least one of embodiments according to the present invention relates to a non-transitory computer-readable medium including a program for causing a user terminal to realize functions to control progress of a video game, a system therefore, and a non-transitory computer-readable medium including a program for causing a server to realize functions to control progress of a video game.

2. Description of the Related Art

Heretofore, there is a video game system in which a system for an actual pinball game is utilized.

In such video game systems, for example, there is one in which a user operates a flipper to return a virtual mobile object and hit a target by the virtual mobile object, whereby a video game proceeds (see Japanese Patent Application Publication No. 2008-149145).

However, such a video game system is just a video game in which a structure of an actual pinball game is applied to the video game as it is. Thus, such a video game system does not make the use of an advantage, which is the video game, and there are some rooms for further improvement in the video game system. Namely, it has been required to improve interest in or the taste of a video game using a mobile object by taking the advantage that is the video game.

### SUMMARY OF THE INVENTION

It is an object of at least one of embodiments according to the present invention to solve the problem described above, and to improve interest in or the taste of a video game in which a moving object is used.

According to one non-limiting aspect of one embodiment of the present invention, there is provided a non-transitory computer-readable medium including a program product for causing a user terminal to realize functions to control progress of a video game.

The functions include a displaying function configured to display a game image, the game image containing a moving object, a game field, and an operation object, the moving object moving in accordance with a virtual attractive force, the moving object being movable in the game field, the operation object being formed in the direction of the attractive force in the game field.

The functions also include a first action controlling function configured to control an action of the moving object so that the moving object finally stops at a predetermined portion of the operation object.

The functions also include a second action controlling function configured to control an action of the moving object in a movement mode, the movement mode being determined in accordance with an input from a user when the moving object is in contact with the predetermined portion.

According to another non-limiting aspect of one embodiment of the present invention, there is provided a system for controlling progress of a video game. The system includes a communication network, a server, and a user terminal.

The system includes a displaying section configured to display a game image, the game image containing a moving object, a game field, and an operation object, the moving object moving in accordance with a virtual attractive force, the moving object being movable in the game field, the operation object being formed in the direction of the attractive force in the game field.

The system also includes a first action control section configured to control an action of the moving object so that the moving object finally stops at a predetermined portion of the operation object.

The system also includes a second action control section configured to control an action of the moving object in a movement mode, the movement mode being determined in accordance with an input from a user when the moving object is in contact with the predetermined portion.

According to still another non-limiting aspect of one embodiment of the present invention, there is provided a non-transitory computer-readable medium including a program product for causing a server to realize functions to control progress of a video game.

The functions include a displaying function configured to display a game image, the game image containing a moving object, a game field, and an operation object, the moving object moving in accordance with a virtual attractive force, the moving object being movable in the game field, the operation object being formed in the direction of the attractive force in the game field.

The functions also include a first action controlling function configured to control an action of the moving object so that the moving object finally stops at a predetermined portion of the operation object.

The functions also include a second action controlling function configured to control an action of the moving object in a movement mode, the movement mode being determined in accordance with an input from a user when the moving object is in contact with the predetermined portion.

According to each of the embodiments of the present application, one or two or more shortages are solved.

### BRIEF DESCRIPTION OF THE DRAWINGS

The foregoing and other objects, features and advantages of the present invention will become more readily apparent from the following detailed description of preferred embodiments of the present invention that proceeds with reference to the appending drawings:

FIG. 1 is a block diagram showing an example of a configuration of a system corresponding to at least one of embodiments according to the present invention.

FIG. 2 is a block diagram showing a configuration of a server corresponding to at least one of the embodiments according to the present invention.

FIG. 3 is a flowchart showing an example of game related processing corresponding to at least one of the embodiments according to the present invention.

FIG. 4 is a flowchart showing an example of an operation of a server side in the game related processing corresponding to at least one of the embodiments according to the present invention.

FIG. 5 is a flowchart showing an example of an operation of a terminal side in the game related processing corresponding to at least one of the embodiments according to the present invention.

FIG. 6 is a block diagram showing a configuration of a user terminal corresponding to at least one of the embodiments according to the present invention.

FIG. 7 is a flowchart showing an example of the game related processing corresponding to at least one of the embodiments according to the present invention.

FIG. 8 is a block diagram showing a configuration of the user terminal corresponding to at least one of the embodiments according to the present invention.

FIG. 9 is a flowchart showing an example of the game related processing corresponding to at least one of the embodiments according to the present invention.

FIG. 10 is a block diagram showing a configuration of the user terminal corresponding to at least one of the embodiments according to the present invention.

FIG. 11 is a flowchart showing an example of the game related processing corresponding to at least one of the embodiments according to the present invention.

FIG. 12 is a block diagram showing a configuration of the user terminal corresponding to at least one of the embodiments according to the present invention.

FIG. 13 is a flowchart showing an example of the game related processing corresponding to at least one of the embodiments according to the present invention.

FIG. 14 is an explanatory drawing for explaining an example of a display screen corresponding to at least one of the embodiments according to the present invention.

FIG. 15 is an explanatory drawing for explaining an example of an action of a moving object corresponding to at least one of the embodiments according to the present invention.

FIG. 16 is an explanatory drawing for explaining an example of an action of the moving object corresponding to at least one of the embodiments according to the present invention.

FIG. 17 is a block diagram showing a configuration of the user terminal corresponding to at least one of the embodiments according to the present invention.

FIG. 18 is a flowchart showing an example of the game related processing corresponding to at least one of the embodiments according to the present invention.

### DETAILED DESCRIPTION OF THE INVENTION

Hereinafter, examples of embodiments according to the present invention will be described with reference to the drawings. In this regard, various kinds of elements in an example of each embodiment, which will be described below, can appropriately be combined with each other in a range where contradiction or the like did not occur. Further, explanation of the content that will be described as an example of an embodiment may be omitted in another embodiment. Further, the content of operations and/or processing with no relationship to characteristic portions of each embodiment may be omitted. Moreover, various kinds of processing that constitute various kinds of processing flows (will be described below) may be carried out in random order in a range where contradiction or the like did not occur in the content of the processing.

### First Embodiment

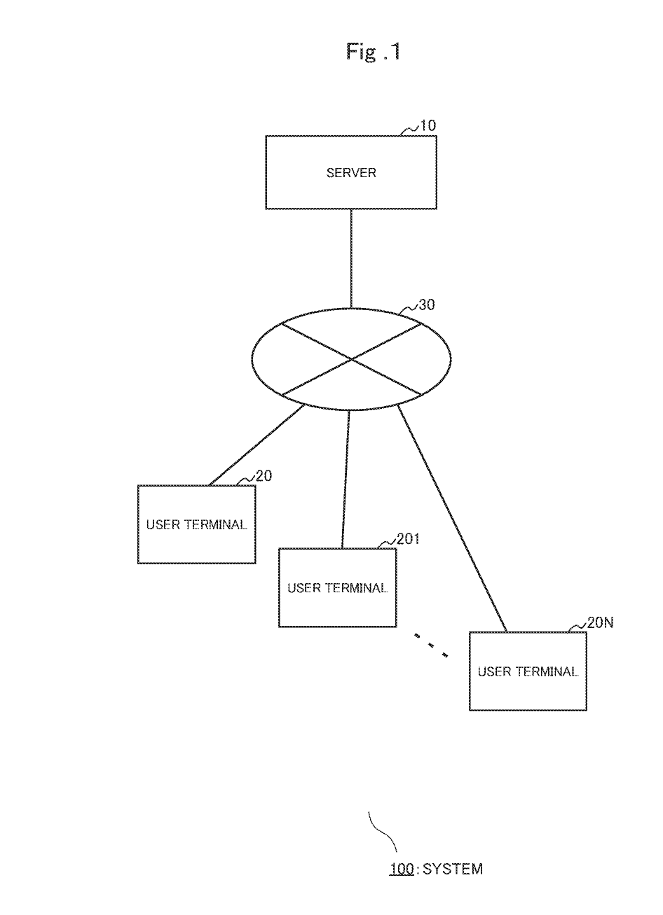

FIG. 1 is a block diagram showing an example of a configuration of a system 100 according to one embodiment of the present invention. As shown in FIG. 1, the system 100 includes a server 10 and a plurality of user terminals 20 and 201 to 20N (“N” is an arbitrary integer), each of which is used by a user of the system. In this regard, a configuration of the system 100 is not limited to this configuration. The system 100 may be configured so that a plurality of users uses a single user terminal, or may be configured so as to include a plurality of servers.

Each of the server 10 and the plurality of user terminals 20 and 201 to 20N is connected to a communication network 30 such as the Internet. In this regard, although it is not shown in the drawings, the plurality of user terminals 20 and 201 to 20N is connected to the communication network 30 by carrying out data communication with base stations managed by a telecommunication carrier by means of a radio communication line.

The system 100 includes the server 10 and the plurality of user terminals 20, 201 to 20N, whereby various kinds of functions for carrying out various kinds of processes in response to an operation of the user are realized.

The server 10 is managed by an administrator of the system 100, and has various kinds of functions to provide information regarding the various kinds of processes to the plurality of user terminals 20, 201 to 20N. In the present embodiment, the server 10 is constructed by an information processing apparatus, such as a WWW server, and includes a storage medium for storing various kinds of information. In this regard, the server 10 is provided with a general configuration for carrying out the various kinds of processes, such as a control section and a communicating section, as a computer. However, its explanation herein is omitted. Further, in the system 100, it is preferable that the server 10 manages various kinds of information from a point of view to reduce a processing load on each of the plurality of user terminals 20, 201 to 20N. However, a storage region may be provided in a state that the server 10 can access the storage region. For example, the server 10 may be configured so as to be provided with a dedicated storage region outside the server 10.

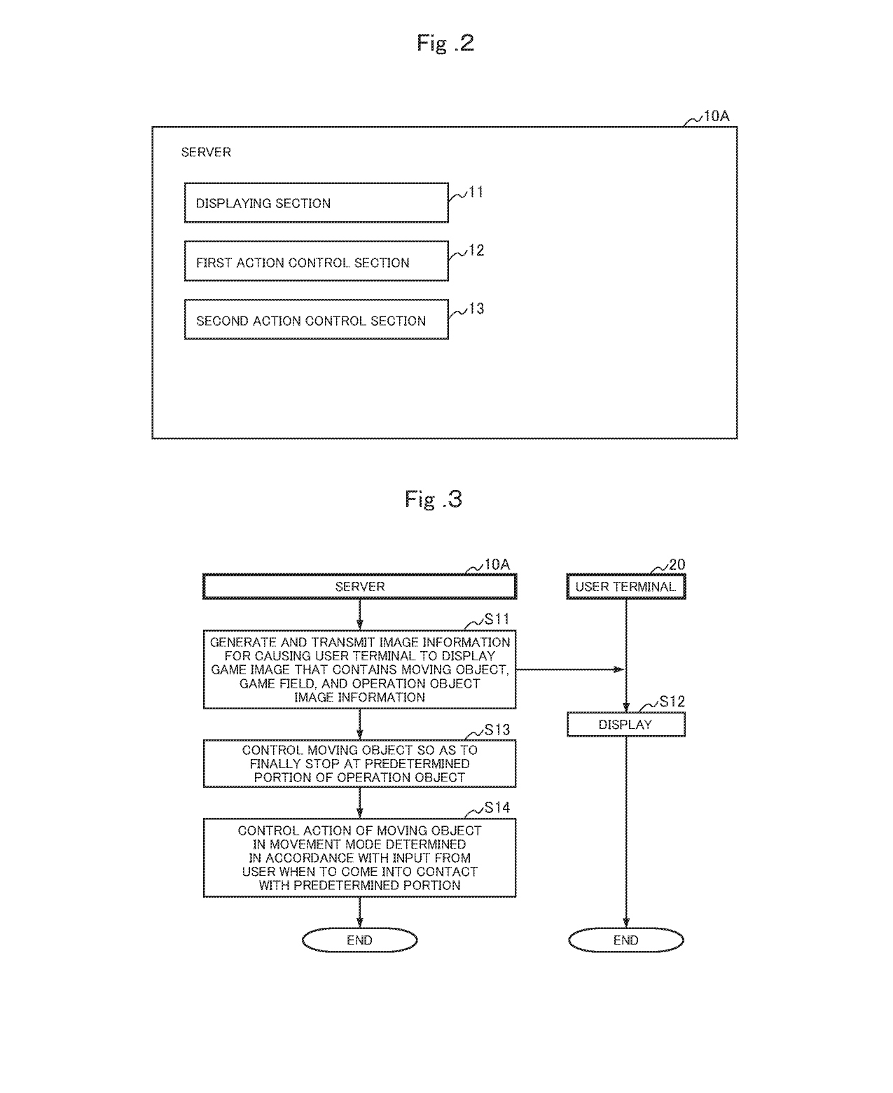

FIG. 2 is a block diagram showing a configuration of a server 10A, which is an example of the configuration of the server 10. As shown in FIG. 2, the server 10A at least includes a displaying section 11, a first action control section 12, and a second action control section 13.

The displaying section 11 has a function to cause a display device to display a game image on a display screen. A moving object, a game field, and an operation object are contained in the game image.

Here the moving means an object that moves within the game field of objects that appear in a video game. The moving object may move or operate on the basis of an operation of the user. Further, an action of the moving object is controlled so as to move in accordance with a virtual attractive force.

Further, the object means an object contained in the game image (that is, a reproduction object), such as a character and an item that appear in the video game, for example. The configuration of the moving object is not limited particularly. However, there are an object represented by a ball shape, and the like, for example.

Further, the virtual attractive force means a force so that a phenomenon, in which an object is attracted, is reproduced in a video game space. It is preferable that the system according to the present embodiment is configured so as to use physics calculations in order to realize the action of the moving object in accordance with the virtual attractive force.

Further, the game field means a fixed virtual area that is set up for progress of the video game. The game field according to the present embodiment is configured so that the moving object can move. Further, the game field according to the present embodiment is configured so that the operation object is contained. In this regard, the configuration of the game field is not limited to this configuration. For example, there is a configuration in which the game field is a space by a virtual wall and containing the operation object.

Further, the operation object means an object that is operated by the user. The operation object plays a role to become one of four walls that surrounds the game field. In particular, the operation object is formed as the wall, which exists in a direction of the attractive force, of the four wall. In the present embodiment, it is preferable that the operation object is configured to continue in such a seamless manner that the moving object goes out to the outside of the game field. In this regard, the operation object may be configured so that the moving object does not go out to the outside of the game field. Alternatively, the operation object may be configured so that openings, each of which has a size through which the moving object cannot go out, are formed intermittently.

Further, the phrase “cause the display device to display an image on the display screen” means causing each of the user terminals 20, 201 to 20N to output an image on the display device included therein by means of communication using the communication network 30. As an example of the configuration to cause the display device to display an image, there is a configuration in which information (image information) generated at a server side is transmitted to each side of the user terminals 20, 201 to 20N. In this regard, the configuration of the image information is not limited particularly. For example, the image information may be information in which an image is compressed, or information for causing each side of the user terminals 20, 201 to 20N to generate an image. As an example of the information in which an image is compressed, there is one used in a cloud game (for example, MPEG). Further, as an example of the information for causing each side of the user terminals 20, 201 to 20N to generate an image, there is one used in an online game (for example, positional information).

The first action control section 12 has a function to control an action of the moving object that moves on the game field. More specifically, the first action control section 12 has a function to control the action of the moving object so that the moving object finally stops at a predetermined portion of the operation object. For example, the first action control section 12 calculates the action of the moving object by means of the physics calculations based on setting values that are set up in advance (for example, setting values set up in advance regarding Mass (weight), Drag (air resistance), and Angular Drag (air resistance of rotation)). As examples of this action, there are actions including collision with other object in a virtual world (or virtual space), a rebound, attraction to the direction of the attractive force by receiving an influence of the attractive force, acceleration by the attractive force, and the like. In the present embodiment, the physics calculation is carried out so that the moving object finally stops on the operation object.

Here, the predetermined portion means a portion that is defined in advance. For example, as an example of the configuration of the predetermined portion, there is a configuration in which the predetermined portion is positioned at any location on a line that constitutes the wall in the game field.

Further, the word “stop” means that an object, which is moving, then stops. In the present embodiment, there is no need to reproduce a phenomenon that the moving object completely stops. For this reason, a state where the moving object slightly moves may be referred to as the “stop” as a state corresponding to the “stop” state. Further, such a slightly moving state may be referred to as a “stopped state”. Further, the first action control section 12 may be configured so that a case where repulsive force against the predetermined portion becomes a predetermined range (for example, a case where the repulsive force is lost) is included in the “stop” (or “stopped state”).

The second action control section 13 has a function to control an action of the moving object in a movement mode determined in accordance with an input from the user when the moving object is in contact with the predetermined portion of the operation object. For example, the second action control section 13 controls the action of the moving object by calculating the movement mode for the moving object on the basis of the physics calculation based on a predetermined rule. The configuration of the movement mode is not limited particularly. However, it is preferable that the movement mode is a mode in which the moving object is flicked out to the game field.

Further, the contact means that one approaches and is in contact with the other. In the present embodiment, there is no need to reproduce a phenomenon in which the moving object completely contacts with the predetermined portion. For this reason, a state where one is slightly apart from the other may be referred to as the “contact” as a state corresponding to the contact. Further, such a state where one is slightly apart from the other may be referred to as a “contact state”.

Further, the movement mode means a state that the moving object moves. The movement mode determined in the present embodiment includes an initial speed when to start movement toward a field, an angle when to start the movement toward the field, and a special movement after starting the movement toward the field (for example, movement so as to curve), for example.

Each of the plurality of user terminals 20, 201 to 20N is managed by a user, and is configured by a communication terminal, such as a cellular phone terminal, a PDA (Personal Digital Assistants), a mobile game device, and a so-called wearable divide, by which the user can play a network delivery type video game, for example. In this regard, a configuration of the user terminal that the system 100 can include is not limited to the examples described above. It may be a configuration in which the user can recognize the video game. As other examples of the user terminal, there are a combination of various kinds of communication terminals, a personal computer, and a stationary game device.

Further, each of the plurality of user terminals 20, 201 to 20N is connected to the communication network 30, and includes hardware (for example, a display device for displaying a game image) and software for carrying out various kinds of processing by communicating with the server 10. In this regard, each of the plurality of user terminals 20, 201 to 20N may be configured so as to be capable of directly communicating with each other without the server 10.

Next, an operation of the system 100 according to the present embodiment will be described.

FIG. 3 is a flowchart showing an example of processing regarding the video game (hereinafter, referred to as “game related processing”), which is carried out by the system 100. In the game related processing according to the present embodiment, processing to cause an event to proceed is carried out. Hereinafter, the case where the server 10A and the user terminal 20 (hereinafter, referred to as a “terminal 20”) carry out the game related processing will be described as an example.

In the game related processing, the server 10A first generates image information for displaying a game image in order to cause the terminal 20 to display the game image, and transmits the generated image information to the terminal 20 (Step S11). Namely, the server 10A causes the terminal 20 to display the game image. Here, the displayed game image contains: the moving object that moves in accordance with the virtual attractive force; the game field in which the moving object can move; and the operation object that is formed in the direction of the virtual attractive force in the game field, for example.

Subsequently, the terminal 20 receives the image information, and causes the display device to display the game image on the display screen on the basis of the received image information (Step S12). For example, the display device is caused to display the game image on the display screen. The game image contains the moving object that moves in accordance with the virtual attractive force, the game field in which the moving object can move, and the operation object that is formed in the direction of the attractive force in the game field.

Subsequently, the server 10A controls an action of the moving object so that the moving object finally stops at the predetermined portion of the operation object (Step S13). For example, the server 10A transmits the game image indicating a control result to the terminal 20 as the image information, whereby the display device is caused to display the game image on the display screen.

Subsequently, the server 10A controls an action of the moving object in a movement mode determined in accordance with an input of the user when the moving object is in contact with the predetermined portion (Step S14), and terminates the processing herein. For example, the server 10A transmits the game image indicating the control result to the terminal 20 as the image information, whereby the display device is caused to display the game image on the display screen.

FIG. 4 is a flowchart showing an example of an operation of the server 10A side in the game related processing. Here, an operation of the server 10A in the system 100 will be described again.

In the game related processing, the server 10A first generates image information for causing the terminal 20 to display a game image. The server 10A transmits the generated image information to the terminal 20, thereby causing the display device of the terminal 20 to display the game image on the display screen (Step S101). The server 10A controls an action of the moving object so that the moving object finally stops at a predetermined portion of the operation object (Step S102). The server 10A controls the action of the moving object in a movement mode determined in accordance with an input of the user when the moving object is in contact with the predetermined portion (Step S103), and terminates the processing herein.

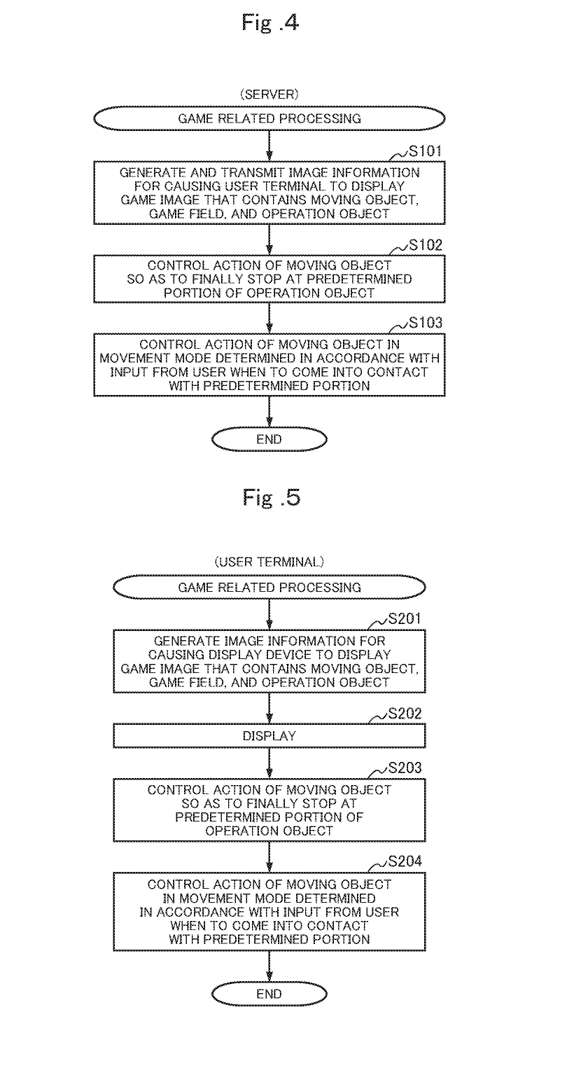

FIG. 5 is a flowchart showing an example of an operation of the terminal 20 side in a case where the terminal 20 carries out the game related processing. Hereinafter, the case where the terminal 20 carries out the game related processing by a single body will be described as an example. In this regard, the terminal 20 is configured so as to include the similar functions to those of the server 10 except for reception of various kinds of information from the server 10. For this reason, its description is omitted from a point of view to avoid repeated explanation.

In the game related processing, the terminal 20 first generates image information for causing the display device to display a game image (Step S201), and causes the display device to display the game image on the display screen (Step S202). The terminal 20 then controls an action of a moving object so that the moving object finally stops at a predetermined portion of an operation object (Step S203). The terminal 20 controls the action of the moving object in a movement mode determined in accordance with an input from the user when the moving object is in contact with the predetermined portion (Step S204), and terminates the processing herein.

As explained above, as one side of the first embodiment, the server 10A configured to control progress of the video game is configured so as to include the displaying section 11, the first action control section 12, and the second action control section 13. Thus, the displaying section 11 causes the display device to display the game image that contains the moving object that moves in accordance with the virtual attractive force, the game field in which the moving object can move, and the operation object that is formed in the direction of the attractive force in the game field; the first action control section 12 controls the action of the moving object so that the moving object finally stops at the predetermined portion of the operation object; and the second action control section 13 controls the action of the moving object in the movement mode determined in accordance with the input from the user when the moving object is in contact with the predetermined portion. Therefore, it becomes possible to improve interest in or the taste of the video game in which the moving object is used.

Namely, as one side of the first embodiment, it is possible to prevent the video game from proceeding because the moving object disappears from the game field due to an influence of the attractive force (for example, the moving object falls down from the game field due to a virtual gravity). Therefore, it becomes possible to improve interest in or the taste of the video game in which the moving object is used.

Further, as it has been mentioned in the example of the first embodiment, it is preferable that the terminal 20 in the system 100 is configured so as to include an input receiving section for receiving an input from the user, and a transmitting section for transmitting the received input to the server 10A; and the server 10A in the system 100 is configured so as to include a receiving section for receiving the input received by the terminal 20 from the terminal 20.

### Second Embodiment

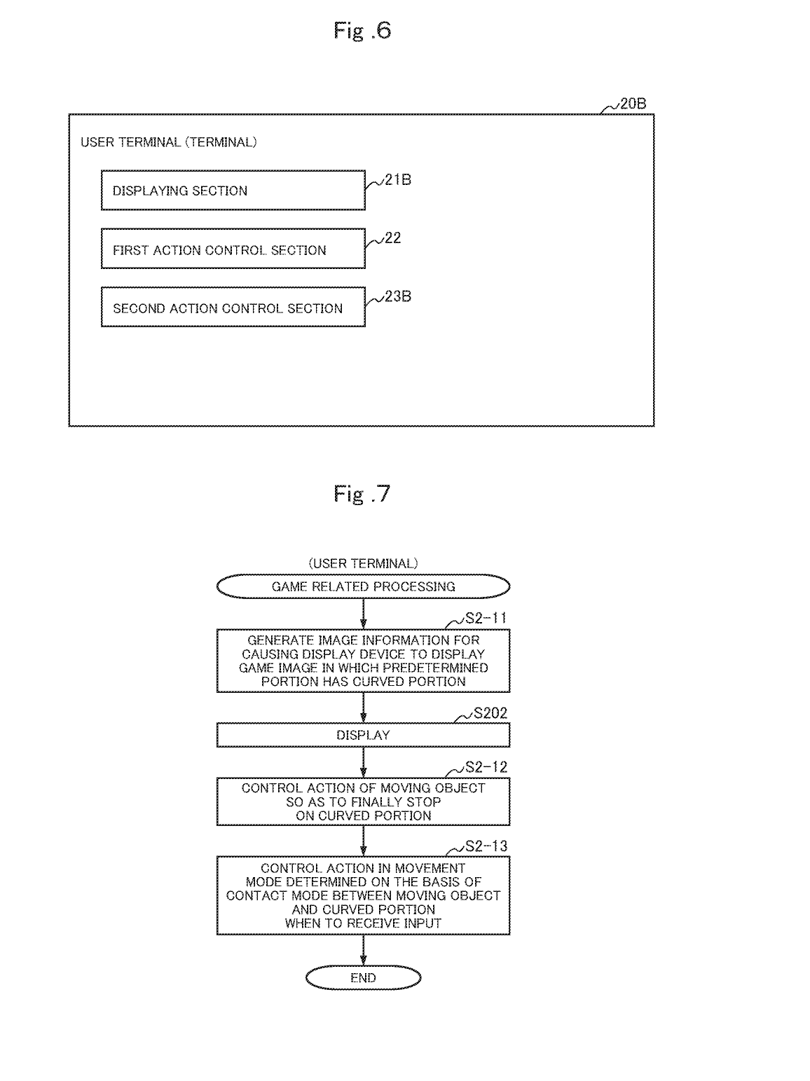

FIG. 6 is a block diagram showing a configuration of a user terminal 20B (hereinafter, referred to as a “terminal 20B”), which is an example of the user terminal 20. In the present embodiment, the terminal 20B at least includes a displaying section 21B, a first action control section 22, and a second action control section 23B.

The displaying section 21B has a function to cause a display device to display a game image in which a predetermined portion has a curved portion.

The second action control section 23B has a function to control an action of a moving object in a movement mode determined on the basis of a contact mode between the moving object and the curved portion when an input is received.

Here, the contact mode means a state that two objects come into contact with each other. As examples of the configuration of the contact mode, there are a contact portion (or a contact point), a contact range between the moving object and the curved portion, and the like.

FIG. 7 is a flowchart showing an example of the game related processing carried out by the terminal 20. Hereinafter, an operation of the terminal 20B will be described as an example. In this regard, an operation of the terminal 20B together with the server 10 is omitted from a point of view to avoid repeated explanation.

In the game related processing, the terminal 20 generates image information for displaying a game image in which a predetermined portion has a curved portion (Step S2-11), and causes the display device to display the game image on a display screen (Step S202).

Subsequently, the terminal 20B controls an action of the moving object so that the moving object finally stops on the curved portion of the operation object (Step S2-12). The terminal 20B then controls the action of the moving object in a movement mode determined on the basis of the contact mode between the moving object and the curved portion when an input is received (Step S2-13), and terminates the processing herein.

As explained above, as one side of the second embodiment, the user terminal 20B is configured so as to include the displaying section 21B, the first action control section 22, and the second action control section 23B. Thus, the displaying section 21B causes the displaying section 21B to display the game image containing the operation object in which the predetermined portion has the curved portion, and the first action control section 22 controls the action of the moving object in the movement mode determined on the basis of the contact mode between the moving object and the curved portion when the input is received. Therefore, it becomes possible to improve interest in or the taste of the video game in which the moving object is used.

Namely, as one side of the second embodiment, it becomes possible to force out the moving object to the game field in any of various movement modes. Therefore, it becomes possible to improve interest in or the taste of the video game in which the moving object is used.

In this regard, it has not been mentioned particularly in the example of the second embodiment. However, the second action control section 23B may be configured to control the action of the moving object so that movement of the moving object starts toward a direction perpendicular to a tangential line of the contact point between the curved portion and the moving object having a spherical shape and a direction of the game field. Namely, the second action control section 23B may be configured to control the action of the moving object so that the moving object moves with an angle based on the contact point between the curved portion and the moving object having the spherical shape.

### Third Embodiment

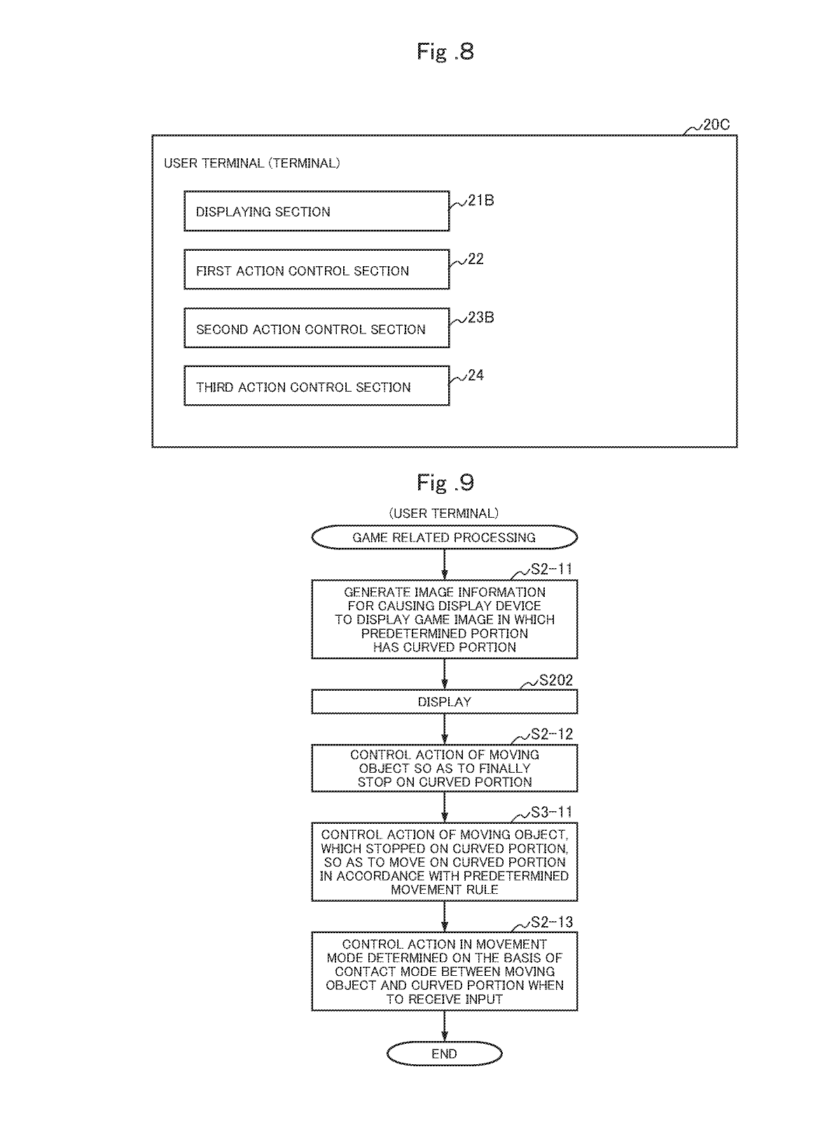

FIG. 8 is a block diagram showing a configuration of a user terminal 20C (hereinafter, referred to as a “terminal 20C”), which is an example of the user terminal 20. In the present embodiment, the terminal 20C at least includes a displaying section 21B, a first action control section 22, a second action control section 23B, and a third action control section 24.

The third action control section 24 has a function to control an action of a moving object so that the moving object, which stopped on a curved portion, moves on the curved portion in accordance with a predetermined movement rule.

Here, the predetermined movement rule means a movement rule that is defined in advance. The configuration of the predetermined movement rule is not limited particularly. However, for example, as an example of the predetermined movement rule, there is a rule for causing the moving object to move on the curved portion like a pendulum.

FIG. 9 is a flowchart showing an example of the game related processing carried out by the terminal 20. Hereinafter, an operation of the terminal 20C will be described as an example. In this regard, an operation of the server 10 is omitted from a point of view to avoid repeated explanation.

The terminal 20C controls an action of the moving object so as to stop on the curved portion of an operation object (Step S2-12). The terminal 20C then controls the action of the moving object so that the moving object, which stopped on the curved portion, moves on the curved portion in accordance with the predetermined movement rule (Step S3-11).

As explained above, as one side of the third embodiment, the user terminal 20C is configured so as to include the displaying section 21B, the first action control section 22, the second action control section 23B, and the third action control section 24. Thus, the third action control section 24 controls the action of the moving object so that the moving object, which stopped on the curved port ion, moves on the curved portion in accordance with the predetermined movement rule. Therefore, it becomes possible to improve interest in or the taste of the video game in which the moving object is used.

Namely, as one side of the third embodiment, it becomes possible to put selection of a movement mode when to cause the moving object to move to the game field into use's hands. Therefore, it becomes possible to improve interest in or the taste of the video game in which the moving object is used.

In this regard, it has not been mentioned particularly in the example of the third embodiment. However, the third action control section 24 may be configured to control the action of the moving object so that the moving object, which became a completely stopped state at a predetermined portion, moves on the curved portion in accordance with the predetermined movement rule.

In this regard, the processing carried out by the third action control section 24 in a case where the predetermined portion has the curved portion has been mentioned in the example of the third embodiment. However, the processing is not limited to such a case. For example, the third action control section 24 may be configured to control the action of the moving object so that the moving object, which is in the completely stopped state at a predetermined portion, moves in the predetermined portion in accordance with the predetermined movement rule.

### Fourth Embodiment

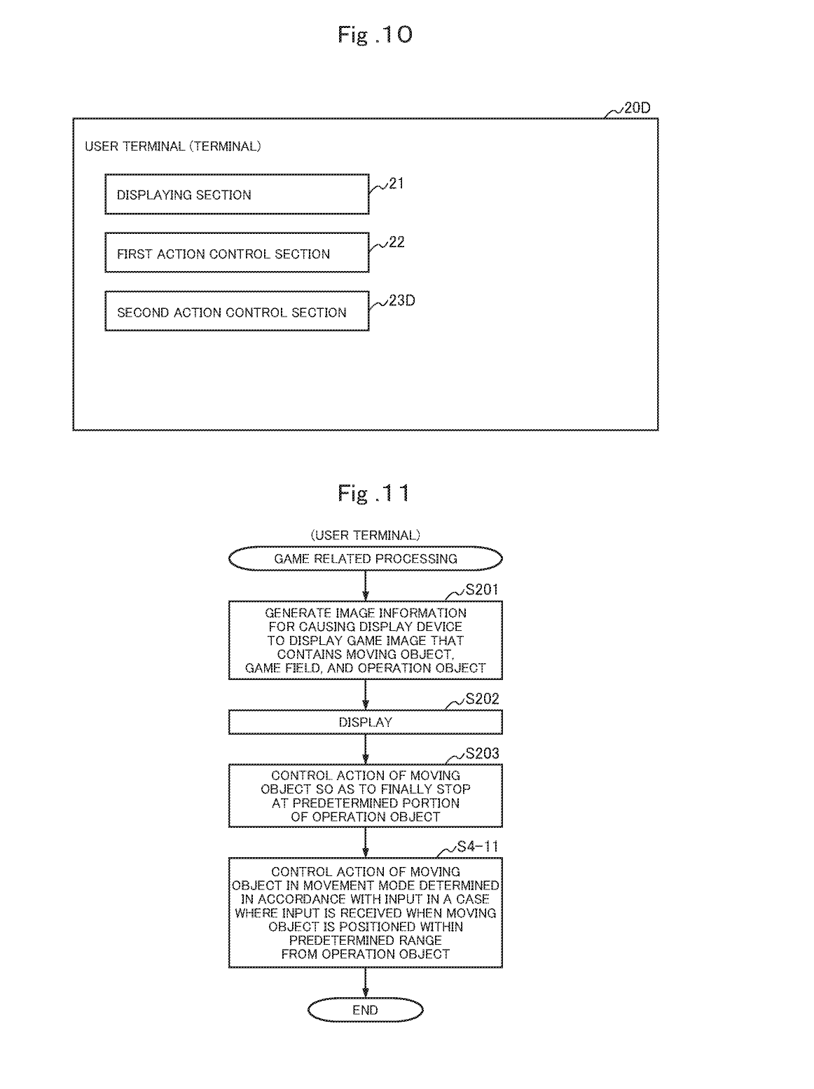

FIG. 10 is a block diagram showing a configuration of a user terminal 20D (hereinafter, referred to as a “terminal 20D”), which is an example of the user terminal 20. In the present embodiment, the terminal 20D at least includes a displaying section 21, a first action control section 22, and a second action control section 23D.

The second action control section 23D has a function to control an action of a moving object in a movement mode determined in accordance with an input in a case where the input is received when the moving object is positioned within a predetermined range from an operation object.

Here, the predetermined range means a range that is defined in advance. Further, it is preferable that the predetermined range from the operation object is configured so as to be a range from a position when the moving object stops at the curved portion of the operation object to a position that is considered so that the moving object does not stop but is equivalent to the stopped state. An example of the configuration of the predetermined range includes a configuration to fall within an action range of the operation object.

FIG. 11 is a flowchart showing an example of the game related processing carried out by the terminal 20. Hereinafter, an operation of the terminal 20D will be described as an example. In this regard, an operation of the terminal 20D together with the server 10 is omitted from a point of view to avoid repeated explanation.

The terminal 20D controls an action of the moving object so as to stop at a predetermined portion of the operation object (Step S203). The terminal 20D then controls the action of the moving object in a movement mode determined in accordance with an input in a case where the input is received when the moving object is positioned within the predetermined range from the operation object (Step S4-11).

As explained above, as one side of the fourth embodiment, the user terminal 20D is configured so as to include the displaying section 21, the first action control section 22, and the second action control section 23D. Thus, the second action control section 23D controls the action of the moving object in the movement mode determined in accordance with the input in a case where the input is received when the moving object is positioned within the predetermined range from the operation object. Therefore, it becomes possible to improve interest in or the taste of the video game in which the moving object is used.

Namely, as one side of the fourth embodiment, various representations of the video game can be carried out. Therefore, it becomes possible to improve interest in or the taste of the video game in which the moving object is used.

### Fifth Embodiment

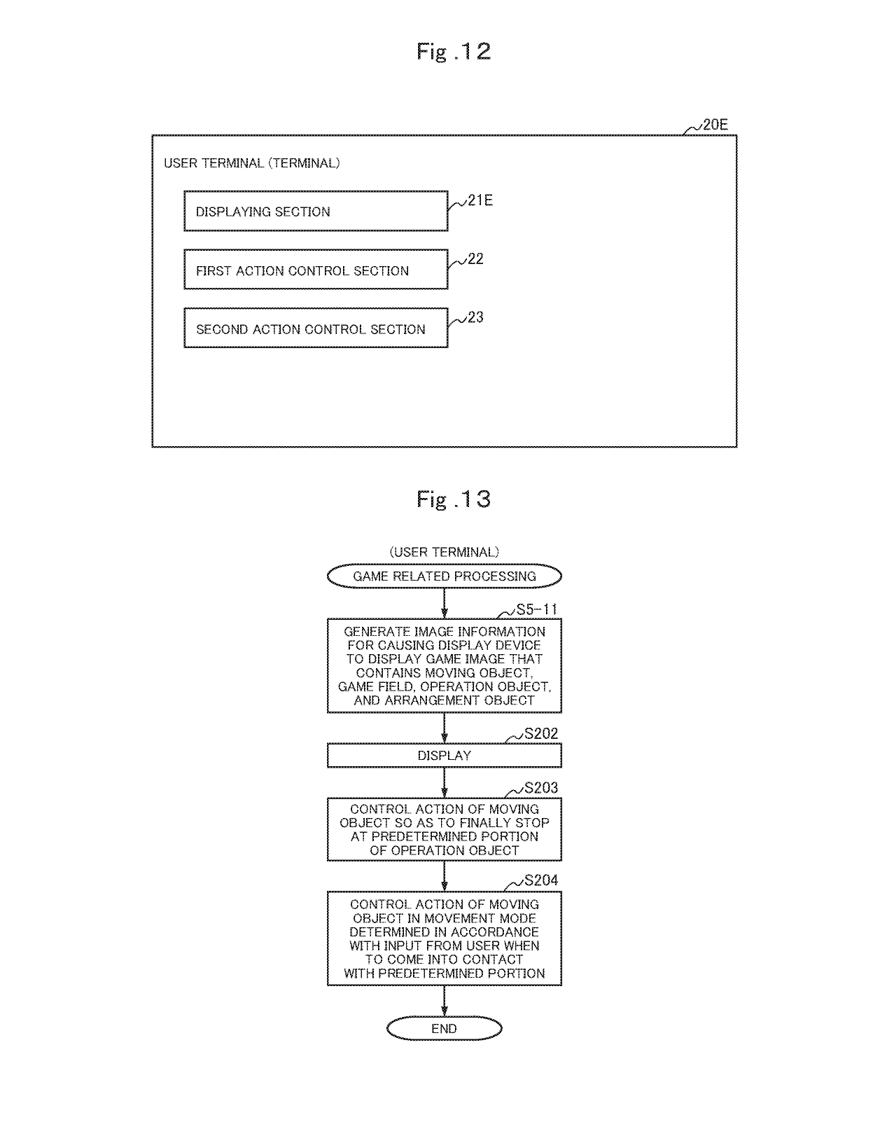

FIG. 12 is a block diagram showing a configuration of a user terminal 20E (hereinafter, referred to as a “terminal 20E”), which is an example of the user terminal 20. In the present embodiment, the terminal 20E at least includes a displaying section 21E, a first action control section 22, and a second action control section 23.

The displaying section 21E has a function to cause a display device to display a game image, which a game field in which an arrangement object that influences on movement of a moving object at the time of contact is arranged, on a display screen.

Here, the arrangement object is an object that is arranged in the game field, and is an object that influences on movement of the moving object. As examples of a configuration of the arrangement object, there are a bumper object, an enemy character object and the like. Further, the system 100 may be configured so that arrangement objects arranged at every game stage are different from each other.

Further, the phrase “influence on” means that physics calculations regarding a collision and rebound action are carried out. Further, the system 100 may be configured so that a parameter when to calculate the collision and rebound action is different from each other for every arrangement object. Namely, the system 100 may be configured so that an action of the moving object after the moving object is in contact with the arrangement object, that is, a collision mode and a rebound mode thereof is different from each other in accordance with the contacted arrangement object.

FIG. 13 is a flowchart showing an example of the game related processing carried out by the terminal 20. Hereinafter, an operation of the terminal 20E will be described as an example. In this regard, an operation of the terminal 20E together with the server 10 is omitted from a point of view to avoid repeated explanation.

In the game related processing, the terminal 20E first generates image information for causing the display device to display a game image that contains a game field in which an arrangement object, which influences on movement of the moving object when to contact it, is arranged (Step S5-11), and causes the display device to display the game image on the display screen (Step S202).

As explained above, as one side of the fifth embodiment, the user terminal 20E is configured so as to include the displaying section 21E, the first action control section 22, and the second action control section 23. Thus, the user terminal 20E causes the displaying section 21E to display the game image, which contains the game field in which the arrangement object that influences on the movement of the moving object at the time of the contact is arranged. Therefore, it becomes possible to improve interest in or the taste of the video game in which the moving object is used.

Namely, as one side of the fifth embodiment, it becomes possible to carry out various representations of the video game using the arrangement object. Therefore, it becomes possible to improve interest in or the taste of the video game in which the moving object is used.

### Sixth Embodiment

In a sixth embodiment, an example of a video game, which is carried out by the system 100 according to the present embodiment, will be described in more detail.

(Outline of Video Game)

The video game according to the present embodiment is a virtual pinball game (or a shooting game) in which a battle proceeds by flicking a moving object to hit a target, which exists on a field, with the moving object. A P2P environment or a communication environment with a client-server system can be adopted. A specific game field is set up for the user, and a battle proceeds by hitting the moving object against an enemy character that is arranged within the game field. The user organizes a set of party from at least one game element (for example, a character), and causes an event (a fight against the enemy character) to proceed by means of the organized party.

(Outline of Moving Object)

The moving object used during an event corresponds to a character owned by the user. Therefore, the event proceeds by means of the moving object according to the character constituting the organized party. A parameter is set up for the character owned by the user. A level value, an offensive power, a defensive power, an HP, and the like are included in the parameter. This parameter influences on an ability of the moving object in a battle. Further, the moving object moves in the game field in accordance with a virtual gravity like a pinball game in which an enemy character is arranged. Further, the user hits the moving object against the enemy character, whereby it is possible to apply a damage to the enemy character.

(Outline of Enemy Character)

Similarly, a parameter is also set up for the enemy character. A level value, an offensive power, a defensive power, an HP, and the like are included in the parameter. The enemy character includes a normal character that is arranged in the game field in advance, and a boss character that appears in accordance with a predetermined rule. Each of the characters are arranged in the game field, and carries out an attack in accordance with a predetermined attack rule. As a configuration example of the attack by the enemy character, there is a configuration in which an attack object is displayed. When the moving object comes into contact with the displayed attack object, an HP of the moving object decreases.

(Game Image)

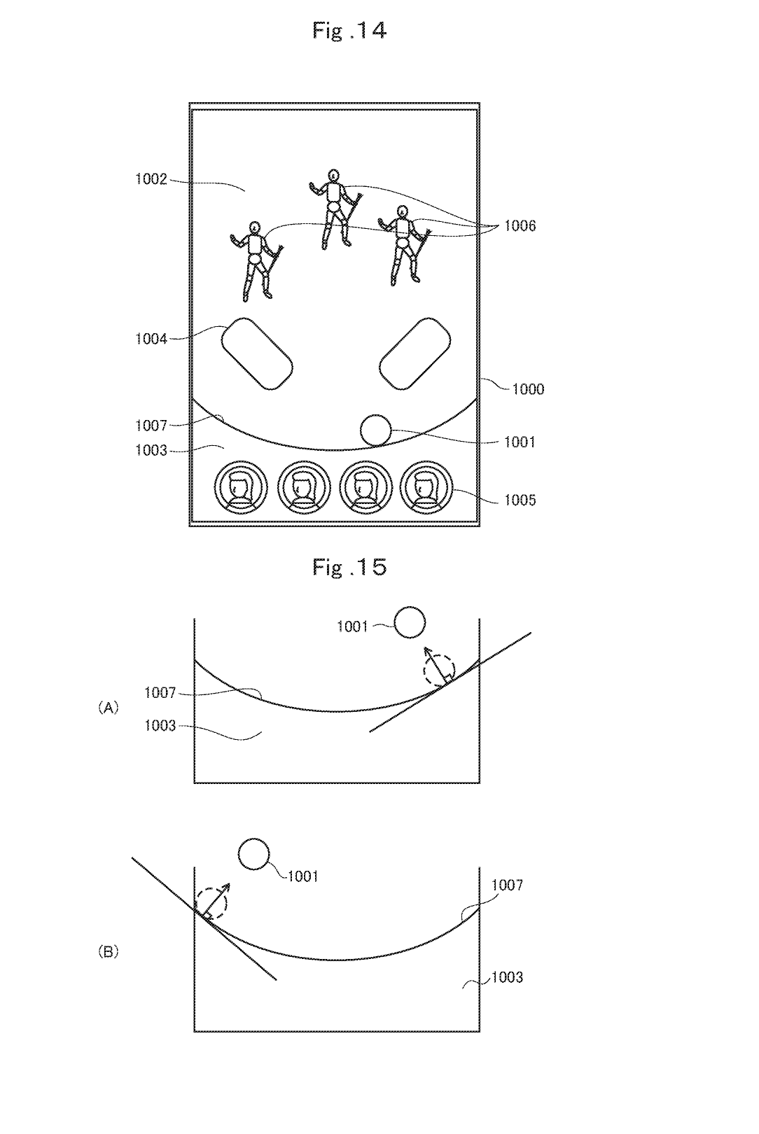

FIG. 14 is an explanatory drawing for explaining an example of a display screen on which a game image is displayed. As shown in FIG. 14, a display screen 1000 contains a moving object 1001, a game field 1002, an operation object 1003, arrangement objects 1004 and 1006, player character information 1005, and a curved portion 1007. The arrangement objects include an arrangement object 1004 that is arranged as a purpose to variegate (or provide variety to) movement of the moving object, and an arrangement object 1006 (enemy character object) as an attack target of the moving object. The player character information 1005 is a region in which information such as an HP of a player character constituting a party is displayed.

(Game Field)

The game field 1002 is a region in which the moving object 1001 moves in accordance with virtual attractive force. Four sides of the game field 1002 is surrounded by a wall. The operation object 1003 is arranged in the game field 1002 according to the present embodiment as the wall of a direction in which the attractive force works of the four walls that surround the game field 1002. In the present embodiment, the attractive force works in a downward direction of the display screen 1000. The lower wall is used as the operation object 1003. Further, such a phenomenon that the moving object moves in accordance with a gravity like an actual pinball is reproduced.

(Operation Object)

The operation object 1003 plays a role as a flipper in a general pinball game. For that reason, the operation object 1003 operates so as to move upward or downward in response to an operational input of the user. A scene (or appearance) in which the moving object 1001 is flicked out from the operation object 1003, is reproduced in response to the operation. Further, the predetermined portion of the operation object 1003 has a curved portion (that is, the curved portion 1007 having a convex portion in a direction of an attractive force). In the present embodiment, the curved portion 1007 having a downwardly convex portion is constituted. For that reason, the moving object 1001 does not fall outside the game field 1002. The operation object may be configured so that openings, each of which has a size through which the moving object 1001 does not fall down, are formed intermittently.

(Arrangement Object)

The arrangement object 1004 is a virtual object that flicks the moving object 1001 when the virtual object comes into contact with the moving object 1001 (which is equivalent to a so-called slingshot and jet bumper in a pinball game).

(Action Modes of Moving Object)

Types of operation controls of a moving object are roughly classified into three types (including a first action control, a second action control, and a third action control). The first action control is a control when the moving object moves within a game field. The second action control is a control when the moving object is flicked out from an operation object. The third action control is a control when the moving object stops on the operation object.

(First Action Control)

In the first action control, an action of the moving object is controlled so as to move in accordance with a virtual attractive force in the game field. The moving object then finally stops (or completely lands on the curved portion while the movement is influenced by an arrangement object or an enemy character in the came field, and a contact with an attack from the enemy character. More specifically, the moving object lands on the curved portion. A rebound of the moving object becomes smaller gradually in accordance with the attractive force and a repulsive force until the moving object stops at the curved portion (that is, on the curved portion). The moving object finally becomes a stopped state.

(Second Action Control)

In a case where an input is received from the user while the moving object moves on the curved portion, an action of the moving object is controlled in a movement mode determined in accordance with the input. FIG. 15 is an explanatory drawing for explaining an example of the action of the moving object that moves by means of a second action control. As shown in FIG. 15, an action of the moving object 1001 is controlled by the second action control so as to be flicked (or forced) out from the operation object 1003. An angle of flicking out at this time is based on a contact position between the moving object and the curved portion 1007 at the time to receive the input. More specifically, as shown in FIGS. 15A and 15B, in the present embodiment, an action of the moving object 1001 is controlled so as to be flicked out toward a direction perpendicular to a tangential line of the contact point between the curved portion 1007 and the moving object 1001 (and toward a direction of the game field 1002). In this regard, it is preferable that the system 100 is configured so that, when the moving object 1001 is positioned within a predetermined range from the curved portion 1007 (that is, when the moving object 1001 does not completely stop but a distance from the curved portion 1007 is small) and the user carries out an input at that time, the action of the moving object 1001 is controlled so that the moving object 1001 is flicked out. Further, the system 100 is configured so that a special control is added to the action of the moving object 1001 in a case where the input of the user is a flick input. For example, the moving object 1001 is curved in accordance with a direction of the flick input after the moving object 1001 is flicked out.

(Third Action Control)

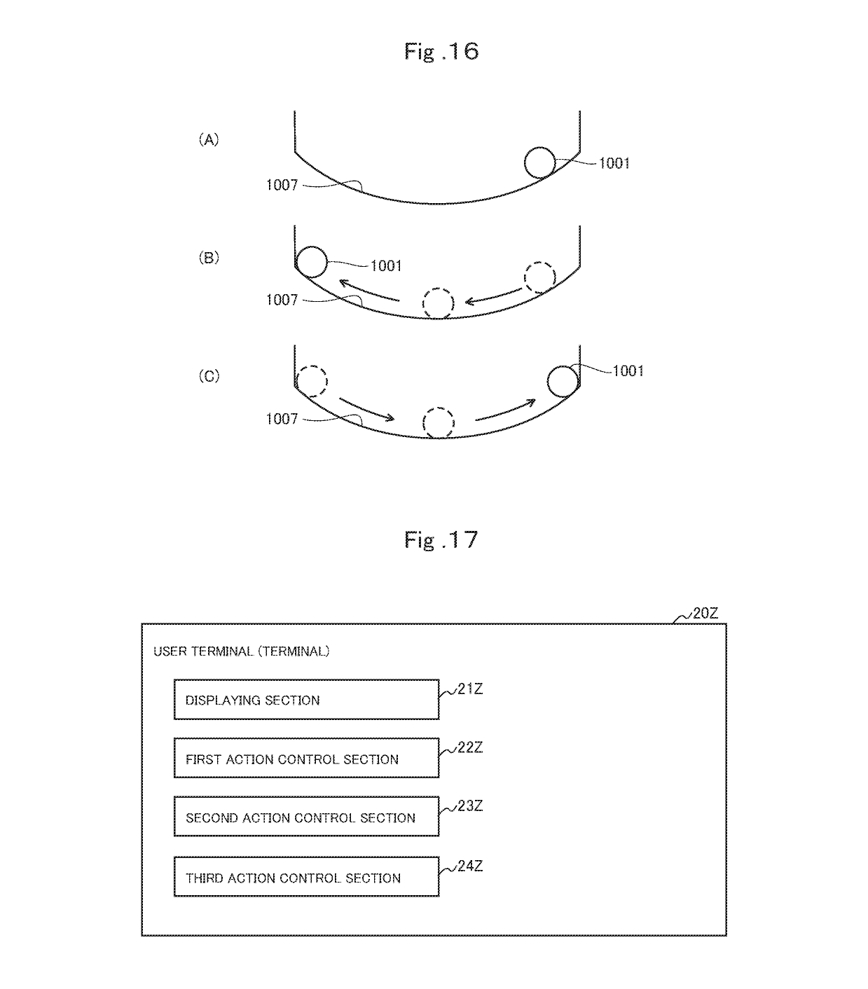

When a moving object comes into contact with a curved portion (in the present embodiment, after the moving object stopped on the curved portion), the moving object moves on the curved portion in accordance with a predetermined movement rule. FIG. 16 is an explanatory drawing for explaining an example of an action of the moving object that moves by means of a third action control. As shown in FIGS. 16A to 16C, the moving object 1001 moves on the curved portion 1007 by means of the third action control like a pendulum. The system 100 may be configured so that the movement on the curved portion 1007 is different from each other for every moving object 1001. Namely, the system 100 may be configured so that the movement mode on the curved portion 1007 of the moving object 1001 is different from each other in accordance with a character selected by the user and corresponding to the moving object 1001. As examples of the configuration of the movement mode, there are a move speed, a movement rule (for example, a rule to move so as to rebound or jump), and the like.

The system 100 according to the sixth embodiment includes the server 10 and the plurality of user terminals 20, 201 to 20N, whereby various kinds of functions for carrying out various kinds of processes in response to an operation of the user are realized. In particular, in the present embodiment, the following explanation will be made using a user terminal 20Z (hereinafter, referred to as a “terminal 20Z”) that is one example of the user terminal 20 as an example.

FIG. 17 is a block diagram showing an example of a configuration of the terminal 20Z.

In the present embodiment, the terminal 20Z at least includes a displaying section 21Z, a first action control section 22Z, a second action control section 23Z, and a third action control section 24Z.

The displaying section 21Z has a function to cause a display device to display a game image, which contains a moving object, a game field, an operation object, and an arrangement object, on a display screen thereof. Here, an action of the moving object is controlled so as to move in accordance with a virtual attractive force. Further, the moving object can move (or is movable) in the game field, and the game field contains the arrangement object. Further, the operation object forms a wall in a direction of the attractive force in the game field (that is, a wall at the game field side). A portion corresponding to the wall in the game field as the operation object is configured as a round-bottom curved portion (that is, a curved portion having a convex portion in the direction of the attractive force). Further, the arrangement object is configured so as to influence on the movement of the moving object.

The first action control section 22Z has a function to carry out a first action control. More specifically, the first action control section 22Z has a function to control an action of the moving object so that the moving object finally stops at a predetermined portion of the operation object by means of physics calculations in which an influence received from the arrangement object is considered. Here, the predetermined portion is a curved portion.

The second action control section 23Z has a function to carry out a second action control. More specifically, the second action control section 23Z has a function to determine whether the moving object is in a contact state with the operation object (that is, the curved portion thereof) or not, and to control an action of the moving object so that the moving object is flicked out in a movement mode determined on the basis of a contact mode in response to an input from the user, which is received when the moving object is in the contact state. As shown in FIGS. 15A and 15B, in the present embodiment, the second action control section 23Z controls the action of the moving object 1001 so that the moving object 1001 is flicked out toward a direction perpendicular to a tangential line of a contact point between the curved portion 1007 and the moving object 1001 (and in a direction of the game field).

The third action control section 24Z has a function to determine whether the moving object is in a stopped state on the curved portion or not, and to control an action of the moving object so that the moving object in the stopped state moves on the curved portion in accordance with the predetermined movement rule. As shown in FIGS. 16A to 16C, the moving object 1001 moves on the curved portion 1007 by means of the third action control like a pendulum.

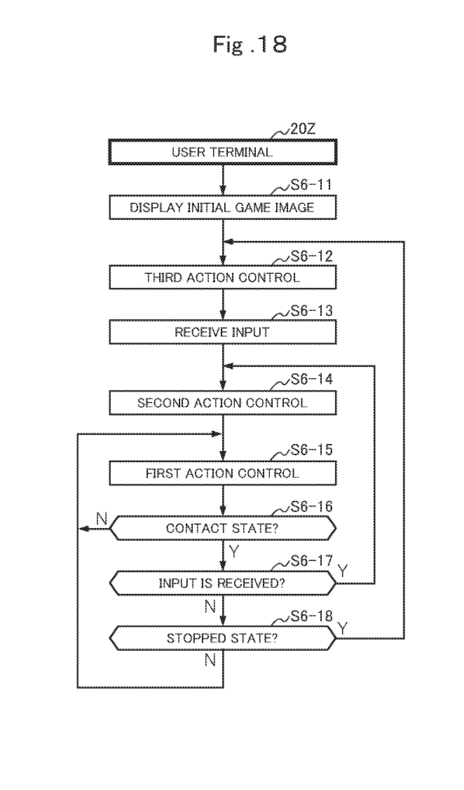

FIG. 18 is a flowchart showing an example of the game related processing carried out by the system 100. Hereinafter, an operation of the terminal 20Z will be described as an example. The following explanation will be made so that the game image is displayed on the display screen of the display device in fixed time intervals in accordance with progress of the video game.

Further, in the following explanation, a flow of a series of processing from a time when one stage is started to a time when the one stage is terminated will be described. Further, the following processing is looped (or repeated) until the stage is cleared. Detailed explanation about processing to determine whether the stage is cleared or not will be omitted. However, as an example, there is a configuration in which the stage is cleared when the enemy character is defeated, for example.

In the game related processing, the terminal 20Z first causes the display device to display a game image at the start of the video game (which is a game image of an initial state, that is, an initial game image) (Step S6-11). In the present embodiment, the video game starts from a state where the moving object is in the stopped state on the curved portion.

Subsequently, the terminal 20Z carries out a control for the moving object by means of the third action control section 24Z (Step S6-12). Namely, the moving object moves along the curved portion like a pendulum.

Then, the terminal 20Z receives an input from the user (Step S6-13). In the present embodiment, the input against the game field is received.

When the input is received from the user during the control by the third action control section 24Z, the terminal 20Z carries out a control for the moving object by means of the second action control section 23Z (Step S6-14). Namely, the moving object starts to move from the curved port ion toward the game field in a movement mode determined in accordance with the input from the user. In this regard, the movement mode may be determined so that a movement mode according to a tap input is different from a movement mode according to a flick input.

When the action control from the curved portion to the game field is carried out, the terminal 20Z carries out a control of the moving object by means of the first action control section 22Z (Step S6-15). Namely, the moving object is operated so that the moving object finally stops on the curved portion of the operation object.

While the moving object is caused to move so as to stop on the curved portion, the terminal 20Z determines whether the moving object is in a contact state or not (Step S6-16). Namely, the terminal 20Z determines whether the moving object is positioned within a predetermined range from the curved portion or not.

In a case where it is determined that the moving object is not in the contact state (“No” at Step S6-16), the terminal 20Z causes the processing flow to shift to Step S6-15, and continues the control for the moving object by means of the first action control section 22Z again.

On the other hand, in a case where it is determined that the moving object is in the contact state (“Yes” at Step S6-16), the terminal 20Z determines whether an input is received from the user or not (Step S6-17).

In a case where it is determined that the input is received from the user (“Yes” at Step S6-17), the terminal 20Z causes the processing flow to shift to Step S6-14, and carries out a control of the moving object by the second action control section 23Z. Namely, the moving object moves from the curved portion toward the game field.

On the other hand, in a case where it is determined that any input is not received from the user (“No” at Step S6-17), the terminal 20Z determines whether the moving object is in a stopped state or not (Step S6-18). Namely, the terminal 20Z determines whether the moving object stops on the curved portion or not.

In a case where it is determined that the moving object is not in the stopped state (“No” at Step S6-18), the terminal 20Z causes the processing flow to shift to Step S6-15, the first action control section 22Z carries out the control of the moving object again.

On the other hand, in a case where it is determined that the moving object is in the stopped state (“Yes” at Step S6-18), the terminal 20Z causes the processing flow to shift to Step S6-12, and the third action control section 24Z carries out the control of the moving object. Namely, the moving object moves along the curved portion like a pendulum.

As explained above, as one side of the sixth embodiment, the terminal 20Z for controlling progress of the video game is configured so as to include the displaying section 21Z, the first action control section 22Z, the second action control section 23Z, and the third action control section 24Z. Thus, the displaying section 21Z causes the display device to display the game image, which contains the moving object that moves in accordance with the virtual attractive force, the game field in which the moving object can move, and the operation object that is formed in the direction of the attractive force in the game field; the first action control section 22Z controls the action of the moving object so that the moving object finally stops at the predetermined portion of the operation object; and the second action control section 23Z controls the action of the moving object in the movement mode determined in accordance with the input from the user when the moving object is in contact with the predetermined portion. Therefore, it becomes possible to improve interest in or the taste of the video game in which the moving object is used.

Namely, as one side of the sixth embodiment, it is possible to prevent progress of the video game from being stopped by means of falling of the moving object (that is, from disappearing from the game field). Therefore, it becomes possible to improve interest in or the taste of the video game in which the moving object is used.

Further, as one side of the sixth embodiment described above, the user terminal 20Z is configured so as to include the displaying section 21Z, the first action control section 22Z, and the second action control section 23Z. Thus, the displaying section 21Z causes the displaying section 21Z to display the game image in which the predetermined portion has the curved portion, and the second action control section 23Z controls the action of the moving object in the movement mode determined on the basis of the contact mode between the moving object and the curved portion when to receive the input. Therefore, it becomes possible to improve interest in or the taste of the video game in which the moving object is used.

Further, as one side of the sixth embodiment described above, the user terminal 20Z is configured so as to include the displaying section 21Z, the first action control section 22Z, the second action control section 23Z, and the third action control section 24Z. Thus, the third action control section 24Z controls the action of the moving object so that the moving object, which is in the stopped state, moves on the curved portion in accordance with the predetermined movement rule in a case where the moving object is in the stopped state. Therefore, it becomes possible to improve interest in or the taste of the video game in which the moving object is used.

Further, as one side of the sixth embodiment described above, the user terminal 20Z is configured so as to include the displaying section 21Z, the first action control section 22Z, and the second action control section 23Z. Thus, the second action control section 23Z controls, in a case where the moving object is in the contact state with the operation object, the action of the moving object in the movement mode determined in accordance with the input when the input is received. Therefore, it becomes possible to improve interest in or the taste of the video game in which the moving object is used.

Further, as one side of the sixth embodiment described above, the user terminal 20Z is configured so as to include the displaying section 21Z, the first action control section 22Z, and the second action control section 23Z. Thus, the displaying section 21Z causes the display device to display the game image, which contains the game field in which the arrangement object that influences on the movement of the moving object at the time of the contact is arranged. Therefore, it becomes possible to improve interest in or the taste of the video game in which the moving object is used.

As explained above, one or two or more shortages can be solved by each of the embodiments according to the present application. In this regard, the effects by each of the embodiments are non-limiting effects or one example of the non-limiting effects.

In this regard, in each of the embodiments described above, each of the plurality of user terminals 20, 201 to 20N and the server 10 carries out the various kinds of processing described above in accordance with various kinds of control programs (for example, a video game processing program) stored in the storage device with which the corresponding terminal or server is provided.

Further, the configuration of the system 100 is not limited to the configuration that has been explained as an example of each of the embodiments described above. For example, the system 100 may be configured so that the server 10 carries out a part or all of the processes that have been explained as the processes carried out by the user terminal. Alternatively, the system 100 may be configured sa that any of the plurality of user terminals 20, 201 to 20N (for example, the user terminal 20) carries out apart or all of the processes that have been explained as the processes carried out by the server 10. Further, the system 100 may be configured so that a part or all of the storing sections included in the server 10 is included in any of the plurality of user terminals 20, 201 to 20N. Namely, the system 100 may be configured so that a part or all of the functions of any one of the user terminal 20 and the server 10 according to the system 100 is included in the other.

Further, the program product may be configured so as to cause a single apparatus that does not include a communication network to realize a part or all of the functions that have been explained as the examples of the respective embodiments described above.

(Appendix)

The explanation of the embodiments described above has been described so that the following inventions can be at least realized by a person having a normal skill in the art to which the present invention belongs.
(1)

A non-transitory computer-readable medium including a program product for causing a user terminal to realize functions to control progress of a video game,

wherein the functions include:

a displaying function configured to display a game image, the game image containing a moving object, a game field, and an operation object, the moving object moving in accordance with a virtual attractive force, the moving object being movable in the game field, the operation object being formed in the direction of the attractive force in the game field;

a first action controlling function configured to control an action of the moving object so that the moving object finally stops at a predetermined portion of the operation object; and

a second action controlling function configured to control an action of the moving object in a movement mode, the movement mode being determined in accordance with an input from a user when the moving object is in contact with the predetermined portion.
(2)

The non-transitory computer-readable medium according to claim (1),

wherein the displaying function includes a function configured to display the game image in which the predetermined portion has a curved portion, and

wherein the second action controlling function includes a function configured to control the action of the moving object in the movement mode determined on the basis of a contact mode between the moving object and the curved portion when the input is received.
(2-1)

The non-transitory computer-readable medium according to claim (2),

wherein the second action controlling function includes a function configured to control the action of the moving object so that the moving object starts to move toward a direction perpendicular to a tangential line of a contact point between the curved portion and the moving object having a spherical shape and a direction of the game field.
(3)

The non-transitory computer-readable medium according to claim (2),

wherein the functions further include:

a third action controlling function configured to control an action of the moving object so that the moving object, which stopped on the curved portion, moves on the curved portion in accordance with a predetermined movement rule.
(3-1)

The non-transitory computer-readable medium according to claim (1),

wherein the functions further include:

a third action controlling function configured to control an action of the moving object so that the moving object, which stopped at the predetermined portion, moves in the predetermined portion in accordance with a predetermined movement rule.
(4)

The non-transitory computer-readable medium according to any one of claims (1) to (3),

wherein the second action controlling function includes a function configured to control the act ion of the moving object in the movement mode determined in accordance with the input in a case where the input is received while the moving object is positioned within a predetermined range from the operation object.
(5)

The non-transitory computer-readable medium according to any one of claims (1) to (4),

wherein the displaying function includes a function configured to display the game image, the game image containing the game field in which an arrangement object is arranged, the arrangement object influencing movement of the moving object at the time of the contact.
(5-1)

The non-transitory computer-readable medium according to any one of claims (1) to (4),

wherein the displaying function includes a function configured to display the game image, the game image containing an arrangement object, and

wherein the controlling function includes a function configured to influence on the moving object when the moving object comes into contact with the arrangement object.
(6)

A non-transitory computer-readable medium including a program product for causing a server to realize at least one function of the functions that the program product described in any one of claims (1) to (5) causes the user terminal to realize, the server being capable of communicating with the user terminal.
(7)

A computer into which the program product contained in the non-transitory computer-readable medium according to any one of claims (1) to (6) is installed.
(8)

A system for controlling progress of a video game, the system comprising a communication network, a server, and a user terminal, the system comprising:

a displaying section configured to display a game image, the game image containing a moving object, a game field, and an operation object, the moving object moving in accordance with a virtual attractive force, the moving object being movable in the game field, the operation object being formed in the direction of the attractive force in the game field;

a first action control section configured to control an action of the moving object so that the moving object finally stops at a predetermined portion of the operation object; and

a second action control section configured to control an action of the moving object in a movement mode, the movement mode being determined in accordance with an input from a user when the moving object is in contact with the predetermined portion.
(9)

The system according to claim (8),

wherein the server includes the first action control section, and the second action control section, and

wherein the user terminal includes:

a receiving section configured to receive information for displaying the game image from the server, and

the displaying section.
(10)

A non-transitory computer-readable medium including a program product for causing a server to realize functions to control progress of a video game,

wherein the functions include:

a displaying function configured to display a game image, the game image containing a moving object, a game field, and an operation object, the moving object moving in accordance with a virtual attractive force, the moving object being movable in the game field, the operation object being formed in the direction of the attractive force in the game field;

a first action controlling function configured to control an act ion of the moving object so that the moving object finally stops at a predetermined portion of the operation object; and

a second action controlling function configured to control an action of the moving object in a movement mode, the movement mode being determined in accordance with an input from a user when the moving object is in contact with the predetermined portion.
(11)

A non-transitory computer-readable medium including a program product for causing a user terminal to realize functions to control progress of a video game,

wherein a server includes:

a displaying function configured to display a game image, the game image containing a moving object, a game field, and an operation object, the moving object moving in accordance with a virtual attractive force, the moving object being movable in the game field, the operation object being formed in the direction of the attractive force in the game field;

a first action controlling function configured to control an action of the moving object so that the moving object finally stops at a predetermined portion of the operation object; and

a second action controlling function configured to control an action of the moving object in a movement mode, the movement mode being determined in accordance with an input from a user when the moving object is in contact with the predetermined portion, and

wherein the functions include:

a receiving function configured to receive, from the server, information regarding the functions included in the server; and

an inputting/outputting function configured to carry out an input or an output corresponding to the functions of the server.
(12)

A non-transitory computer-readable medium including a program product for causing a user terminal to realize at least one function of the functions that the program product described in claim (11) causes the server to realize, the user terminal being capable of communicating with the server.
(13)

A server into which the program product contained in the non-transitory computer-readable medium according to claim (11) is installed.
(14)

A method of controlling progress of a video game, the method comprising:

a displaying process configured to display a game image, the game image containing a moving object, a game field, and an operation object, the moving object moving in accordance with a virtual attractive force, the moving object being movable in the game field, the operation object being formed in the direction of the attractive force in the game field;

a first action controlling process configured to control an action of the moving object go that the moving object finally stops at a predetermined portion of the operation object; and

a second action controlling process configured to control an action of the moving object in a movement mode, the movement mode being determined in accordance with an input from a user when the moving object is in contact with the predetermined portion.
(15)

A method of controlling progress of a video game by a system, the system comprising a communication network, a server, and a user terminal, the method comprising:

a displaying process configured to display a game image, the game image containing a moving object, a game field, and an operation object, the moving object moving in accordance with a virtual attractive force, the moving object being movable in the game field, the operation object being formed in the direction of the attractive force in the game field;

a first action controlling process configured to control an action of the moving object so that the moving object finally stops at a predetermined portion of the operation object; and

a second action controlling process configured to control an action of the moving object in a movement mode, the movement mode being determined in accordance with an input from a user when the moving object is in contact with the predetermined portion.

According to one of the embodiments of the present invention, it is useful for a video game using a moving object.

What is claimed is:

1. A non-transitory computer-readable medium including a program product for causing a user terminal to realize functions to control progress of a video game,
wherein the functions include:
a displaying function configured to display a game image, the game image containing a moving object, a game field, and an operation object, the moving object moving in accordance with a virtual attractive force, the moving object being movable in the game field, the operation object being formed in the direction of the attractive force in the game field;
a first action controlling function configured to control an action of the moving object so that the moving object finally stops at a predetermined portion of the operation object; and
a second action controlling function configured to control an action of the moving object in a movement mode, the movement mode being determined in accordance with an input from a user when the moving object is in contact with the predetermined portion.

2. The non-transitory computer-readable medium according to claim 1,
wherein the displaying function includes a function configured to display the game image in which the predetermined portion has a curved portion, and
wherein the second action controlling function includes a function configured to control the action of the moving object in the movement mode determined on the basis of a contact mode between the moving object and the curved portion when the input is received.

3. The non-transitory computer-readable medium according to claim 2,
wherein the functions further include:
a third action controlling function configured to control an action of the moving object so that the moving object, which stopped on the curved portion, moves on the curved portion in accordance with a predetermined movement rule.

4. The non-transitory computer-readable medium according to claim 1,
wherein the second action controlling function includes a function configured to control the action of the moving object in the movement mode determined in accordance with the input in a case where the input is received while the moving object is positioned within a predetermined range from the operation object.

5. The non-transitory computer-readable medium according to claim 1,
wherein the displaying function includes a function configured to display the game image, the game image containing the game field in which an arrangement object is arranged, the arrangement object influencing movement of the moving object at the time of the contact.

6. The non-transitory computer-readable medium according to claim 2,
wherein the second action controlling function includes a function configured to control the act ion of the moving object so that the moving object starts to move toward a direction perpendicular to a tangential line of a contact point between the curved portion and the moving object having a spherical shape and a direction of the game field.

7. The non-transitory computer-readable medium according to claim 1,
wherein the functions further include:
a third action controlling function configured to control an action of the moving object so that the moving object, which stopped at the predetermined portion, moves in the predetermined portion in accordance with a predetermined movement rule.

8. The non-transitory computer-readable medium according to claim 1,
wherein the displaying function includes a function configured to display the game image, the game image containing an arrangement object, and
wherein the controlling function includes a function configured to influence on the moving object when the moving object comes into contact with the arrangement object.

9. A non-transitory computer-readable medium including a program product for causing a server to realize at least one function of the functions that the program product described in claim 1 causes the user terminal to realize, the server being capable of communicating with the user terminal.

10. A computer into which the program product contained in the non-transitory computer-readable medium according to claim 1 is installed.

11. A system for controlling progress of a video game, the system comprising a communication network, a server, and a user terminal, the system comprising:
a displaying section configured to display a game image, the game image containing a moving object, a game field, and an operation object, the moving object moving in accordance with a virtual attractive force, the moving object being movable in the game field, the operation object being formed in the direction of the attractive force in the game field;
a first action control section configured to control an action of the moving object so that the moving object finally stops at a predetermined portion of the operation object; and
a second action control section configured to control an action of the moving object in a movement mode, the movement mode being determined in accordance with an input from a user when the moving object is in contact with the predetermined portion.

12. A non-transitory computer-readable medium including a program product for causing a server to realize functions to control progress of a video game,
wherein the functions include:
a displaying function configured to display a game image, the game image containing a moving object, a game field, and an operation object, the moving object moving in accordance with a virtual attractive force, the moving object being movable in the game field, the operation object being formed in the direction of the attractive force in the game field;
a first action controlling function configured to control an action of the moving object so that the moving object finally stops at a predetermined portion of the operation object; and
a second action controlling function configured to control an action of the moving object in a movement mode, the movement mode being determined in accordance with an input from a user when the moving object is in contact with the predetermined portion.
